(19) United States
(12) Patent Application Publication
(10) Pub. No.: US 2008/0010172 A1
(43) Pub. Date: Jan. 10, 2008

(54) Traceability System

(75) Inventor: Ian Magill, Antrim (GB)

Correspondence Address: STOUT, UXA, BUYAN & MULLINS LLP, 4 VENTURE, SUITE 300, IRVINE, CA, 92618, US

(73) Assignee: TraceAssured Limited; The Food Park, Craigavon, NIR (GB)

(21) Appl. No.: 11/661,302

(22) PCT Filed: Aug. 26, 2005
(86) PCT No.: PCT/GB05/03344

§ 371 Date: Aug. 20, 2007

(30) Foreign Application Priority Data
Aug. 26, 2004 (GB) 0419092.2

(51) Int. Cl. G06Q 10/00

(52) U.S. Cl. 705/28

(57) ABSTRACT

A traceability system for managing traceability information within production chains, where the production chain is modelled as a set of transfers of contents between uniquely identified containers. All containers have a globally unique, unchanging identifier. Containers have their identifiers permanently attached in a form such as a barcode label or a RFID chip. Traceability information is collected by making a permanent record of each transfer of contents from one container to another. The identifiers of the two containers and the time is captured. When a particular usage of a container finishes the end of usage is recorded. The recorded data can be queried to find all container usages that have had transferred to them, directly or indirectly, any of the contents of a particular container usage, or all container usages that have had any of their contents transferred, directly or indirectly, to a particular container usage.

This invention relates to tracing items within production chains, for example food production chains or pharmaceutical production chains.

Production chains for products such as prepared meals and modern drugs are often very complex. Traceability systems are required that allow all the constituents of an item in such a chain to be easily determined. There is a converse requirement for the easy discovery of all the items in a production chain in which a particular item may have ended up. Those forward- and backward-traceability problems are easily stated but are in practice very difficult to solve. Existing systems are paper-based, costly to use, and organisation-specific. The traceability information they capture is error prone, incomplete and difficult to interrogate. There is a particular need for improved traceability systems within the food and agriculture industries, due to consumer and legislative pressures.

The object of this invention is to provide a traceability system that is suitable for use in any of several different industries, relatively simple to install and use and yet provides ready access to complete and correct traceability information for its users.

Accordingly, this invention provides a traceability system for managing traceablity information within a production chain that models the production chain as a set of transfers of contents between uniquely identified containers. All items that hold production material in the production chain are considered to be containers, and the invention captures traceability information by recording transfers of contents between one container and another.

Preferably, all entities used to hold production material are represented as uniquely identified containers. Preferably each container's identifier is fixed. Preferably, an appropriate physical representation of a container's identifier is always attached to the container; the appropriate physical form for an identifier may be a barcode label, a barcode tag, a RFID, a handwritten label or any other suitable technique.

Preferably, the containers in the system are partitioned into a configurable set of container types.

Preferably there is a configurable set of production contents types, that are used to model the different kinds of material used in the production chain.

Preferably, each individual transfer of any of the contents of one container to another container is captured by recording the container identifiers of the two containers and the time of the transfer; the record of the transfer may be recorded by using a barcode scanner, an RFID reader, keyboard input or any other suitable technique, depending on the physical form of the container's identifiers.

Preferably each usage of a container is captured by recording the container identifier together with the time the usage of the container ended. The end of usage may be recorded by a system operator or may be automatically recorded by the system, when a configurable set of criteria are satisfied.

The type of contents being held in a container at a particular time may be set manually by a system operator or inferred automatically by the system where that is possible.

Preferably, a container being allocated its identifier has appropriate information permanently associated with it that uniquely identifies the container from the perspective of the supplier of the container.

Preferably, all the recorded traceability information is held in a database system that can be queried by users of the system, via computer networks such as the internet, leased lines, virtual private networks, local area networks, wide area networks, and also via telephone based networks such as GPRS networks, 3G networks and all other types of computer and telephone network considered appropriate.

Preferably, a user of the system can obtain automatically, for a particular usage of a container, details of all other container usages that contain any of the contents of the original usage, due to direct or indirect contents transfer. Preferably, a user of the system can obtain automatically, for a particular usage of a container, details of all other container usages, that have had any of their contents transferred, directly or indirectly, to the usage of concern. Preferably, the usage information obtained is represented as a network diagram on a computer graphics terminal and, more preferably, within the network diagram, container usages are represented as nodes and contents transfers between usages are represented as arrows between nodes. Still more preferably, moving the terminal mouse pointer over a container usage node or a contents transfer arrow results in the display of some or all of the information held by the system for that usage or transfer. Preferably such activity is carried out interactively at a computer graphics terminal; more preferably a network diagram representing portions of the permanently recorded traceability information can be incrementally created, expanded, reduced and explored by the user of the computer graphics terminal.

Preferably, each container has associated with it a parent container, where the parent container is the container in which the container is physically located at a point in time.

Preferably, the physical movement of a container from the container in which it is located to another container is captured by recording the container identifier of the moved container, the container identifier of the container to which the moved container is moved, and the time of the container movement; the record of the movement may be recorded by using a barcode scanner, an RFID reader, keyboard input or the like, depending on the physical form of the containers' identifiers.

Also according to the invention there is provided a method of tracking items in a production chain, comprising:

(i) recording a first identifier that is marked on a first container that contains an item;

(ii) recording a second identifier that is marked on a second container;

(iii) transferring at a time t the item from the first container to the second container;

(iv) recording in a database the first identifier, the second identifier and an indicator of the time t.

The term ‘production chain’ should of course not be regarded as limited to a linear production sequence; the chain may be a production ‘web’, with multiple production lines taking place in parallel and converging or diverging during certain transfers, for example when different items are mixed in a mixing machine or different items are produced from a mix.

An item is an instance of an ingredient, product, or constituent of any kind used or produced within the production chain, the usage of which is to be traced. A container holds an item used in the production chain. The database is preferably a remote database; a remote database is a database that is not housed at the same site as either the first or second container; for example, if the containers were in a factory, the remote database would not be in the factory (that does not preclude the database being in a factory that forms some other part of the production chain; the database is remote form at least one of the transfers).

The method of the invention may be implemented in several different companies, covering the whole production chain. Although the food production chain is of particular interest, the invention in its broadest form is not restricted to a specific sector or industry. Different companies operating different parts of the production chain can, within the broad concept of the invention, model their processes using their own terminology and technical language. However, because a central database is employed, traces are not limited to a particular company but may extend across the whole production chain. Thus the method may be carried out by different organisations in different parts of the production chain, with the database being a central database used by each of the organisations.

Thus the present invention distinguishes items in the production chain (such as ingredients and products) from the containers that hold the items; that significantly reduces the number of identifiers that need to be generated, compared with the prior-art system described in WO 02/067063 A1. Containers may be marked prior to addition of an item or may be permanently marked and re-used, obviating the need for marking at every step. The invention is not restricted to processes that change the composition of an item and containers within containers may be tracked, so in a food production chain, for example, a product can be tracked through chills, transport by lorries and the like. From the point of view of the implementation of the database in which details of the identifiers are stored, the concept of ‘container-to-container transfer’ is more flexible and simpler to implement than the earlier ‘ingredient-process-product’ model.

Another advantage of the method is that the granularity of the record of the production chain held in the database may be selected. For example, the first container may be a pallet containing feed and the second container may be a chicken, with the transfer being effected by feeding the feed to the chicken. Alternatively, the first container may be a lorry (in turn containing the pallets) and the second container may be a farm (containing the chickens). Thus the containers for which steps (i) to (iv) are carried out may be lowest-level containers or may be higher-level containers, which in turn contain lowest-level containers (directly or in or one or more levels of intermediate containers). It will be understood that transfers between lower-level containers may take place within a higher-level container (for example, a production line of several stages may operate in a factory). A choice can be made as to whether to carry out steps (i) to (iv) in respect of the lowest level containers, giving a detailed picture of this part of the chain, or in respect of higher level containers, giving a less detailed picture. A different choice may be made at different parts of the overall production chain.

Preferably, steps (i) to (iv) are carried out for at least two, preferably at least three, more preferably at least five, still more preferably at least ten linked or consecutive stages in the production chain. More preferably, steps (i) to (iv) are carried out for transfers throughout the whole, or substantially the whole, production chain, preferably forming an unbroken link from all initial ingredient items to one or more final product items (it will be understood from the above discussion that this does not require every transfer to be recorded, as a higher-level container can contain transfers that need never be recorded as long as transfers to and from the higher level container are recorded). It may be, however, that steps (i) to (iv) are carried out for transfers that do not form a complete link. Other methods of tracing may be employed in the remaining parts of the chain. Earlier parts of the chain may be ignored and their product items regarded as input items.

Preferably, the transfer from the first container to the second container is a direct transfer, with no, or at least no significant, intervening steps (any intervening step will generally itself be describable in terms of transfer(s) between containers and is preferably so described).

The first and second identifiers may be alphanumeric codes or bar-codes or Radio Frequency Identification Chips or any other form of marking that is easily noted and recorded. The identifiers may thus be noted by hand, by entry into a portable computing device, by using a barcode reader or by any other suitable method. Preferably, the identifiers are read by a reader that has been configured to be specific to the (natural or legal) person carrying out the transfer or to an entity such as a factory in which the transfer takes place.

The recording at the remote database preferably takes place over a telecommunications link. It may take place, for example, over an internet link. The identifiers may be recorded using a secure communications protocol, such as a virtual private network.

The method may comprise an intermediate step of recording at a local database the first identifier, the second identifier and an indicator of the time t, with that data being passed on to the remote database in due course.

The production chain may be producing a food product, which may be for human consumption or may be for animal consumption.

The method may further comprise the step of generating the identifier for the first or second container. The generated identifier may be written on the container using a writer.

The method may comprise the step of reusing the container, retaining the identifier. Alternatively, the container may be a single-use container. The production chain may include both reusable and single-use containers.

For re-usable containers, the method preferably also includes the step of recording at the remote database a demarcation event, that is an indication that usage of the container has changed. For example, in the case of a food-mixer, a demarcation event may be recorded each time the mixer becomes empty or each time a clean-down takes place. Preferably, the demarcation event data stored at the database comprise the container's ID and the time of the change of usage.

The method may further comprise the step of querying the central database to identify container transfers upstream or downstream from a specified container. A telecommunications link may be utilised in querying the central information store. The query may communicated to the central information store using a secure communications protocol, such as a virtual private network.

The method may further include the steps of communicating to operators of processes related to a query a request for authorisation to release data in response to that query and processing their responses.

Also according to the invention there is provided an apparatus for tracing items in a production chain, comprising a database comprising a plurality of records of transfers of items between containers in the production chain, at least some of the transfers being at locations remote from the apparatus, each record comprising an identifier of a first container, an identifier of a second container and an identifier of the time of transfer of an item from the first container to the second container, the apparatus further comprising an interface for receiving the identifiers from the remote location via a telecommunications link, an interface for inputting a query by a user regarding the transfers and a query engine for generating a response to the query and providing it to the user.

Preferably, the query engine generates details of at least part of the production chain upstream or downstream of an element specified by the user. The apparatus thus enables upstream or downstream tracing, for example to identify all containers through which items used to make a product have passed or all containers though which an item, or items made from that item, have passed.

Preferably, the interface for receiving the identifiers and/or the interface for inputting a query is a secure communications link, such as a virtual private network.

Also according to the invention there is provided a method of tracking items in a production chain comprising a plurality of transfers of items between containers, the method comprising:

(i) receiving from a remote location a record comprising an identifier of a first container, an identifier of a second container and an identifier of the time of transfer of an item from the first container to the second container;

(ii) recording the record in a database.

Preferably, the method further comprises the steps:

(iii) receiving a query regarding the production chain; and

(iv) generating details of at least part of the production chain from a plurality of the records and providing the details in response to the query.

Such records may be received from a plurality of locations that are remote from each other.

Preferably, the method further comprises the steps of communicating to operators of processes related to a query a request for authorisation to release data in response to that query and processing their responses.

A preferred embodiment of the invention will now be described with reference to the accompanying drawing in which:

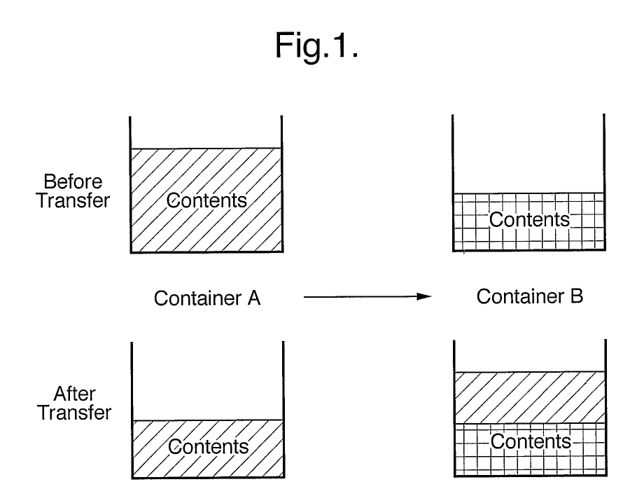

FIG. 1 shows two containers before and after a contents transfer between them.

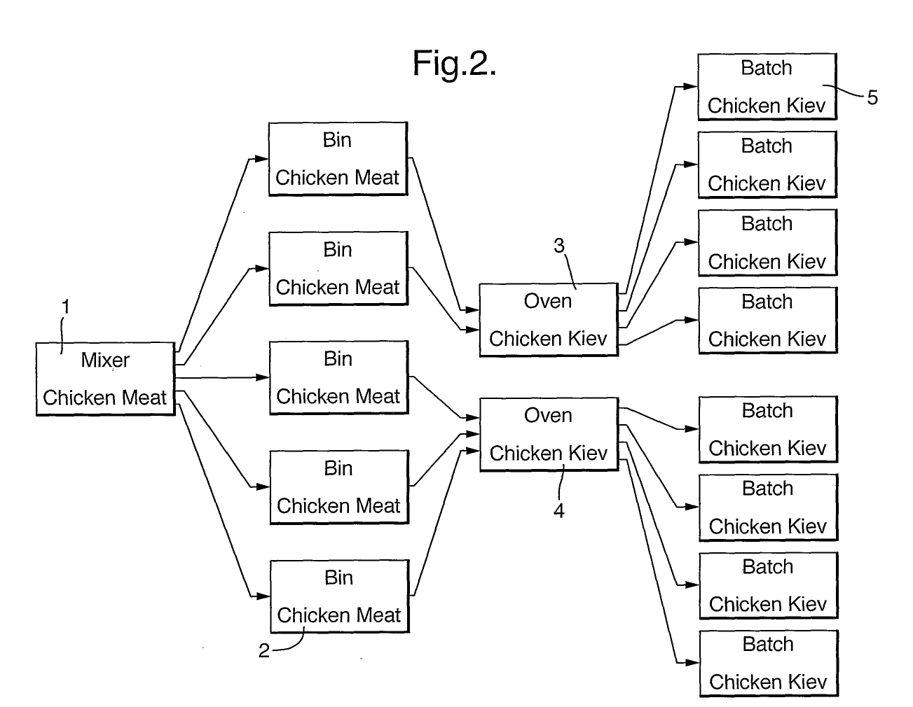

FIG. 2 shows an example traceability network diagram, a forward trace from a container usage showing all usages that have received any of the contents of the original usage.

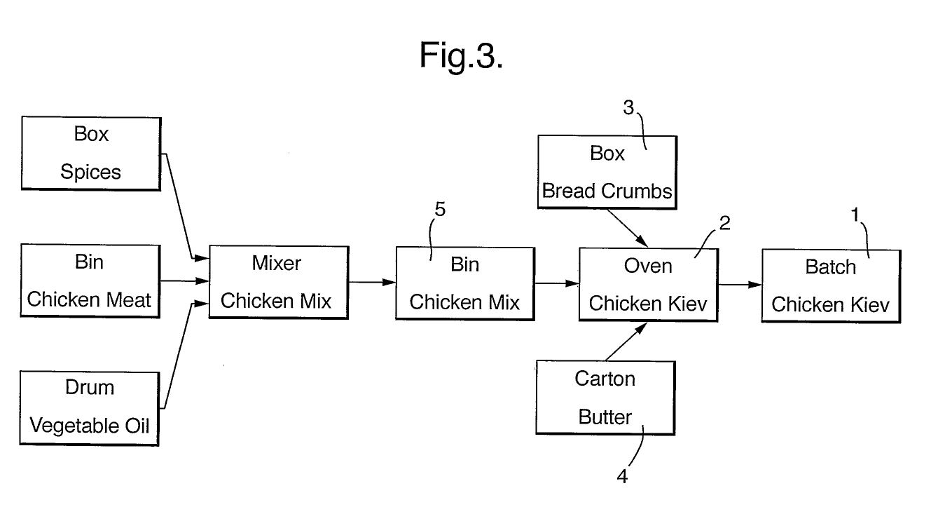

FIG. 3 shows an example traceability network diagram, a backward trace for a container usage showing all the usages that have had some of their contents transferred to the usage of concern.

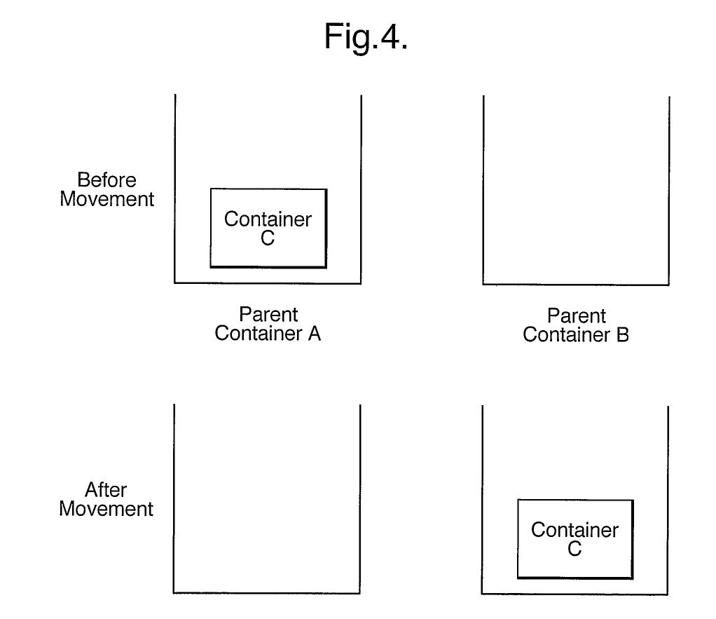

FIG. 4 shows the movement of a container from one parent container to another parent container.

The invention represents each entity in a production chain that holds production material as a “container”. Containers are used to hold production materials. Production materials are described herein as “contents”. Examples of containers with contents are:
a pack containing bread crumbs,
a dolly containing minced chicken meat,
a production line blender containing butter,
a field containing potato plants,
a ship containing wheat,
a cow containing milk,
a milk tanker containing milk,
a farm containing cows,
a retail tin containing soup.

Each container is given what in principle is a globally unique, unchanging identifier. A container's identifier remains physically attached to the container in a suitable physical format such as a barcode label, an Radio-frequency identifier (RFID) tag or in some other way.

The containers modelled in the system can be partitioned into a configurable set of container types. Individual organisations choose the container types they need to model the containers they use. Examples of container types are,
Mixer, Bin, Box, Cow, Ship, Blender, Packet, Milk Tanker, Drum, Factory

Similarly, the contents modelled in the system can be partitioned into a configurable set of contents types. Individual organisations choose the contents types they need to reflect their specific production processes. Examples of contents types are,
Butter, Milk, Chicken Meat Mix, Beef Soup, E421, Water, Fertiliser, Emulsifier, Grain

A container may be reused many times or may be thrown away after a single use. Examples of reusable containers are.
Food Processors, Fields, Cows, Lorries, Ships, Tanks, Silos, Pallets, Dollies

Examples of single-use containers are
Prepared meal trays, Cardboard boxes of food ingredients, Plastic drug bottles.

Identifiers for containers can be generated at any time. For reusable container types, such as food mixers, the container identifier is typically generated at the beginning of the system's deployment. For container types that are used only once and have many instances, such as cardboard boxes used to contain food ingredients, the container identifiers can be generated dynamically as needed or can be prepared in batches before attachment.

The example system according to the invention models the food chain as a set of contents transfers between containers. A contents transfer takes place when any of the contents of a container are moved into another container (FIG. 1). Some examples of contents transfer are,
Spraying a field with a batch of fertiliser,
Packaging a prepared meal as it emerges from an oven,
Filling a beer barrel from a brewery storage tank,
Taking a portion of the grain in a ship and putting it into a feed mill input silo,
Killing a cow and putting some of its meat into a metal bin,
Adding each of the ingredients of a meat mix to a meat mixer,
Taking some meat mix from a meat mixer and packaging it,
Adding grain harvested from a field to a lorry,
Administering a dose of antibiotics to a sow,
Boxing the eggs collected in a hen-house,
Adding a drum of vegetable oil to a tank in a factory,
Loading some sheep from a flock into a lorry.

When a contents transfer takes place the identifiers of the two containers are recorded along with the time the transfer was carried out. The identifiers may be read automatically using a barcode scanner, RFID reader or other device depending on the physical format of the container identifiers.

To trace the the flow of contents through a container over time, each discrete usage of the container is demarcated. That is done by recording the end of each particular usage for the container: the container's identifier and the time the usage ended are recorded. The end of usage may be manually recorded by a production operative. It may alternatively be automatically recorded when a configurable condition becomes true for the container; one example of such a condition is a specific number of transfers having taking place to or from the a container; another example of end of usage condition for a container is when a specific period of time has passed.

A container contains only a single type of contents at any given time. The single contents type may be made up of a variety of different contents types transferred into the container, as for example when creating a meat mix in a mixer.

Subject to that constraint the following are allowed:
The contents of one container can be transferred to any number of other containers,
A container can have transferred to it some or all of the contents of any number of other containers,

Transfers of contents to and from a container can be freely interspersed.

When the type of contents being held in a container changes, a permanent record of that is made, manually by an operative or by automatic inference where that is possible. The information recorded is the container's identifier, the new contents type and the time at which the contents were changed. The configured contents types are each given a unique identifier physically represented as a barcode label, which can be scanned by a barcode reader to help automate the setting of contents types for containers.

When a container from a source external to the traceability system is first given its container identifier, some external information can be permanently recorded for the container. That information should be sufficient to uniquely identify the container from the perspective of the external source; examples are a batch number, a lot number, or a use by date. The container's identifier, the time and the external information are recorded by the system.

All the permanently recorded information is held in a computer database, which can be queried by users of the traceability system. Queries are carried out via computer networks such as the internet, leased lines, virtual private networks, local area networks, wide area networks, and also via telephone based networks such as GPRS networks, 3G networks and any other type of computer and telephone network that is suitable.

The traceability system provides two distinct kinds of traceability query, forward traces and backward traces.

A backward trace for a particular usage of a container provides details of all other container usages that have had any of their contents transferred directly or indirectly to the usage of concern.

A forward trace for a particular usage of a container provides details of all other container usages, that contain any of the contents of the original usage, due to direct or indirect contents transfer.

The traceability system supports the display on computer graphics terminals of the traceability information that the system holds. In particular the traceability data can be displayed as a network diagram, where container usages are represented as nodes, and contents transfers are represented as arrows between nodes. Moving the terminal's mouse pointer over a container usage node results in the display of some or all the information held about the usage. Moving the terminal's mouse pointer over a contents-transfer arrow results in the display of the information held about the transfer. A user of the system can interactively explore the recorded traceability data, by creating, expanding, reducing and generally navigating the traceability network diagrams.

FIG. 2 shows an example traceability network diagram: a forward trace from a container usage showing all usages that have received any of the original usages' contents. The forward trace is for the usage 1, a container of type Mixer containing Chicken Meat. The chicken meat has been transferred to five containers 2 of type Bin. The meat has subsequently been transferred to two Oven containers, 3 and 4, as an ingredient in a Chicken Kiev recipe. Finally, for each oven the contained Chicken Kiev is transferred to four Batch containers 5.

FIG. 3 shows a second example traceability network diagram: a backward trace for a container usage showing all the usages that have had some of their contents transferred to the usage of concern. The backward trace is for container usage 1, a container of type Batch containing Chicken Kiev. It has had transferred to it Chicken Kiev from an Oven container, 2. The Oven container has had transferred to it a Box of Bread Crumbs 3, a Carton of Butter 4, and a Bin of Chicken Mix 5. The Bin of Chicken Mix was transferred from a Mixer that had transferred to it a Box of Spices, a Bin of Chicken Meat, and a Drum of Vegetable Oil. At least some of all the usages shown in the diagram will have ended up in the Batch of Chicken Kiev 1.

Each container in the system has an associated parent container. The parent container is used to keep track of the physical location of a container. In many cases this will be a container representing the organisation that owns the container. However a parent container may be any other container. Examples are:
A cow with a field parent container,
A box with a batch parent container,
A shipping container with a ship parent container,

The physical movement of a container from one parent container to another, for example, a cow moving from a field to a lorry, is captured by permanently recording the container identifier of the moved container, the container identifier of the new parent container, i.e. the container to which the moved container is moved, and the time (FIG. 4). The movement information may be recorded with the help of a barcode scanner, an RFID reader, or the like, depending on the physical form of the container identifiers.

1. A method of tracing items within a production chain, comprising: receiving a first signal, representing a first identifier that is associated with a first container within the production chain; receiving a second signal, representing a second identifier that is associated with a second container within the production chain, into which second container the contents of the first container have been transferred; and recording the first identifier and the second identifier in a database.

2. A method as claimed in claim 1, wherein all entities used to hold production material are represented as uniquely identified containers.

3. A method as claimed in claim 1, wherein an appropriate physical representation of a container's identifier is attached to the container.

4. A method as claimed in claim 1, wherein the containers in the system are partitioned into a configurable set of container types.

5. A method as claimed in claim 1, wherein there is a configurable set of production contents types, that are used to model the different kinds of material used in the production chain.

6. A method as claimed in claim 1, wherein each individual transfer of any of the contents of one container to another container is captured by recording the container identifiers of the two containers and the time of the transfer.

7. A method as claimed in claim 1, wherein each usage of a container is captured by recording the container identifier together with the time the usage of the container ended, and wherein the end of usage is recorded by a system operator, or is automatically recorded by the system, when a configurable set of criteria are satisfied.

8. A method as claimed in claim 1, wherein the type of contents being held in a container at a particular time is set manually by a system operator or inferred automatically by the system.

9. A method as claimed in claim 1, wherein a container being allocated its identifier has information associated with it that uniquely identifies the container from the perspective of the supplier of the container.

10. A method as claimed in claim 1, wherein each container has associated with it a parent container, in which the container is physically located at a point in time.

11. A method as claimed in claim 10, wherein the physical movement of a container from the parent container in which it is located to another parent container is captured by recording the container identifier of the moved container, the container identifier of the parent container to which the moved container is moved, and the time of the container movement.

12. Apparatus for tracing items within a production chain, comprising: an interface for receiving a signal representing a first identifier associated with a first container within the production chain; an interface for receiving a signal representing a second identifier associated with a second container within the production chain, into which second container the contents of the first container have been transferred; and a database arranged for recording of the transfer by recording the first identifier and the second identifier.

13. Apparatus as claimed in claim 12, further comprising a query interface arranged to receive queries of the database via a computer network.

14. Apparatus as claimed in claim 12, which is arranged to provide, for a particular usage of a container, details of all other container usages that contain any of the contents of the particular usage, due to direct or indirect contents transfer.

15. Apparatus as claimed in claim 12, which is arranged to provide, for a particular usage of a container, details of all other container usages that have had any of their contents transferred, directly or indirectly, to the particular usage.

16. Apparatus as claimed in claim 14, further comprising a reporting interface, arranged to provide signals representing container usage details as a network diagram, in which container usages are represented as nodes and contents transfers between usages are represented as arrows between nodes.

17. Apparatus as claimed in claim 16, further comprising a computer-graphics terminal and wherein the network diagram is incrementally creatable, expandable, reducable and explorable by the user of a computer graphics terminal.

18. A system for enabling tracing of items within a production chain, wherein the production chain is modelled as a set of transfers of contents between uniquely identified containers.

19. (canceled)
